(19) United States
(12) Patent Application Publication
(10) Pub. No.: US 2009/0028706 A1
(43) Pub. Date: Jan. 29, 2009

(54) Vertical Axle Helix Monoblock Wind Turbine

(76) Inventors: STEFAN IOANA, Germantown, MD (US); Nicolae Mugea, Brasov (RO)

Correspondence Address: MICHAEL RIES, 318 PARKER PLACE, OSWEGO, IL, 60543, US

(21) Appl. No.: 12/177,889

(22) Filed: Jul. 23, 2008

Related U.S. Application Data
(60) Provisional application No. 60/952,220, filed on Jul. 26, 2007.

(51) Int. Cl. F03D 7/06; F03D 9/00; F03D 3/06

(52) U.S. Cl. 416/41; 290/55; 416/223 R

(57) ABSTRACT

VAHM has a rotor helix type, vertical axle, omni directional foil, which incorporates a 3 helix monoblock blade which transforms wind energy into electrical energy, via stand alone batteries. Rotor movement begins at a 2-3 m/s wind speed and provides a self-braking momentum at over 20 m/s wind speed.

This application claims the benefit of U.S. Provisional Patent Application Ser. No. 60/952,220 filed Jul. 26, 2007.

### TECHNICAL FIELD & BACKGROUND

The present invention generally relates to a vertical axle helix monoblock wind turbine. More specifically, the present invention relates to a wind turbine that is also called flower power that is mounted on a tri pod or any vertical axle stand.

The present invention has a main element of the invention that is the wind turbine itself. The rotor, also called flower power, is a required element and is mounted on a tri pod or any vertical axle standing. The vertical axle, tripod, concrete base pole, represents the base of the wind turbine element. The present invention is a gear planet assembly that amplifies the movement of rotor to current generator. The current generator provides current. A photovoltaic pane provides current in absence of the wind. The vertical axle helix monoblock or VAHM wind turbine generates current by transforming the wind energy, through the rotor to batteries.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of vertical axle helix monoblock wind turbine, in accordance with one embodiment of the present invention;

FIG. 2 illustrates a drawing of vertical axle helix monoblock wind turbine, in accordance with one embodiment of the present invention;

FIG. 3 illustrates a drawing of vertical axle helix monoblock wind turbine, in accordance with one embodiment of the present invention; and

FIG. 4 illustrates a drawing of vertical axle helix monoblock wind turbine, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

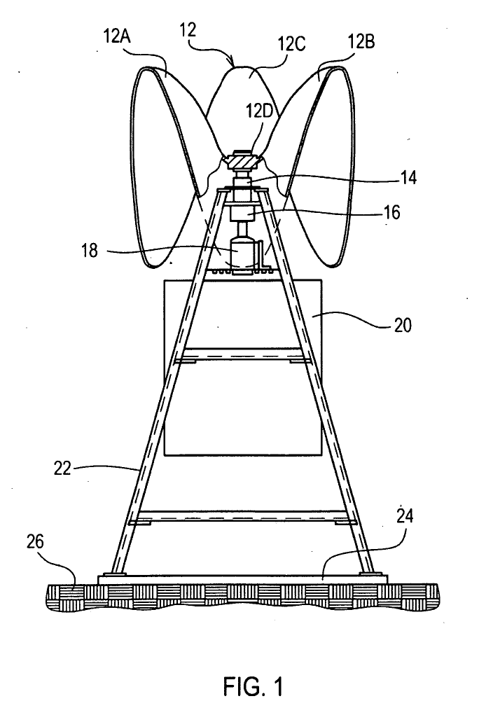

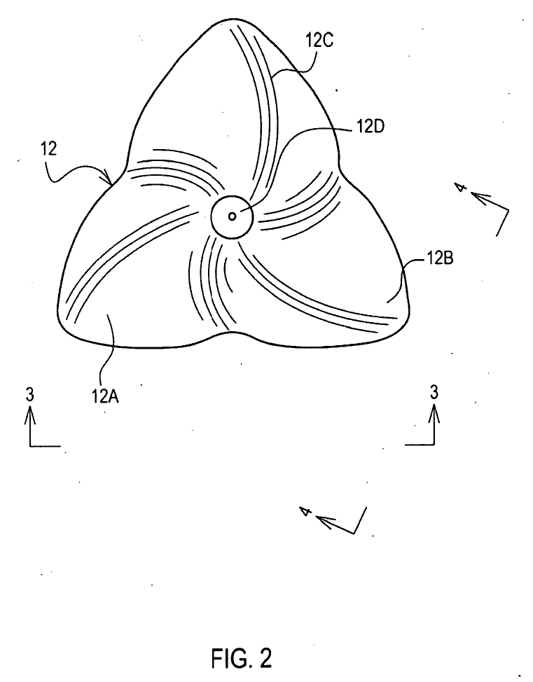

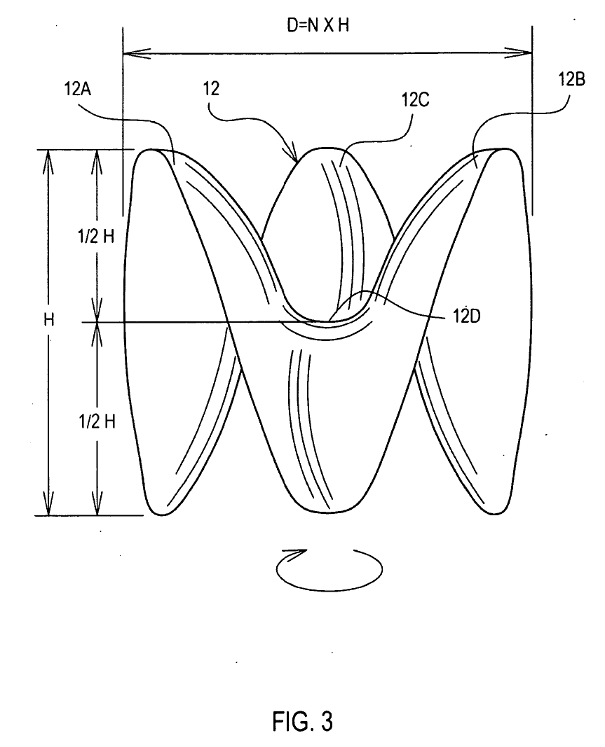

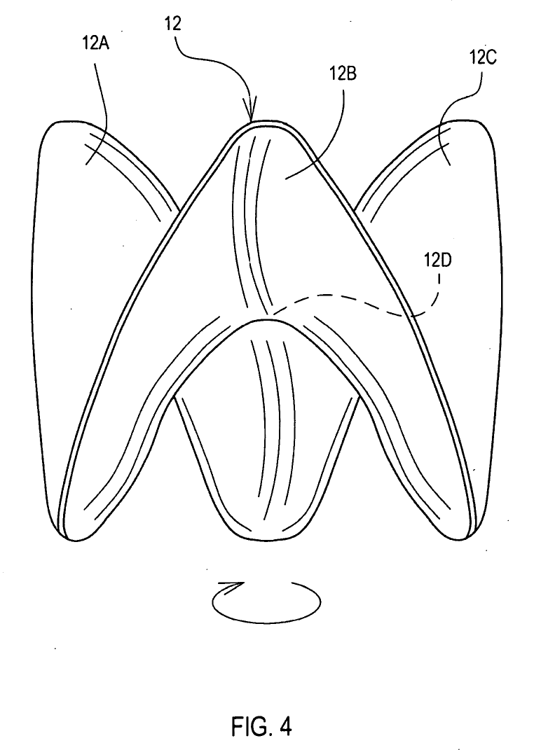

Referring now to FIGS. 1 to 4 as in one embodiment shown is a vertical helix mono block wind turbine 10. The vertical axle helix monblock wind turbine has a revolutionary design in low speed otor technology. The present invention promises cost effectiveness to develop wind energy production to urban, suburban and rural markets. The vertical axle helix monoblock has a helix type rotor 12, vertical axle, omni directional foil, which incorporates a 3 helix mono block blade which transforms wind energy into electrical energy, via stand alone batteries.

The rotor movement begins at a 2-3 m/s wind speed and provides a self braking momentum at over 20 m/s wind speed. The VAHM 10 generates current by transforming the wind energy through a rotor 12 to batteries. The 3 helix mono block blade rotor 12 is the main element and is mounted to a tripod support frame 22 which is mounted to a concrete base 24. The gear planet assembly 16 amplifies the movement of the rotor to generator 18 which provides current. The photovoltaic panel 20 will provide current in the absence of wind.

Referring to FIGS. 1 to 4 shown is a three helix mono block blade rotor 12, a first blade of the three helix monoblock blade rotor 12a, a second blade of the three helix monoblock blade rotor 12b, a third blade of the three helix mono block blade rotor 12c and a central axis of the three mono block blade rotor 12d. Also shown is an axle 14, a gear planet 16, a generator 18, a photo voltaic panel 20, a tripod support frame 22, a concrete base 24 and earth 26.

What is claimed is:

1. A device comprising:
a VAHM with a rotor helix type, vertical axle, omni directional foil, which incorporates a 3 helix monoblock blade which transform wind energy into electrical energy, via stand alone batteries.

2. The device of claim 1 wherein rotor movement begins at a 2-3 ml/s wind speed.

3. The device of claim 1 wherein a self-braking momentum at over 20 m/s wind speed is provided.

4. The device of claim 1 wherein rotor movement begins at a 2-3 ml/s wind speed and provides a self-braking momentum at over 20 m/s wind speed.

5. A device comprising:
a VAHM with a rotor helix type, vertical axle, omni directional foil, which incorporates a 3 helix monoblock blade which transform wind energy into electrical energy, via stand alone batteries, rotor movement begins at a 2-3 ml/s wind speed and provides a self-braking momentum at over 20 m/s wind speed.
